(19) United States
(12) Patent Application Publication
(10) Pub. No.: US 2014/0090742 A1
(43) Pub. Date: Apr. 3, 2014

(54) NATURAL GAS MANIFOLD FOR DUAL-FUEL TRAILERS

(71) Applicants: Billy Don Coskrey, Duncan, OK (US); Jonathan Barrett Coulter, Duncan, OK (US)

(72) Inventors: Billy Don Coskrey, Duncan, OK (US); Jonathan Barrett Coulter, Duncan, OK (US)

(21) Appl. No.: 13/973,246

(22) Filed: Aug. 22, 2013

Related U.S. Application Data
(63) Continuation-in-part of application No. 13/631,127, filed on Sep. 28, 2012.

(51) Int. Cl. F17C 13/00

(52) U.S. Cl. CPC F17C 13/004
USPC 141/1; 141/35; 29/428

(57) ABSTRACT

A fuel delivery system comprising: a fuel source; a first trailer comprising a first manifold in fluid communication with a first fuel train; and a second trailer comprising a second manifold in fluid communication with a second fuel train, wherein the first and second manifolds are connected in series to the fuel source using flexible hose tubing.

### CROSS-REFERENCE TO RELATED APPLICATIONS

This application is a continuation-in-part of U.S. patent application Ser. No. 13/631,127, filed on Sep. 28, 2012; the contents of which is incorporated herewith in its entirety by reference.

### BACKGROUND

The present disclosure relates generally to subterranean drilling and completion operations and, more particularly, the present disclosure relates to a method and apparatus for supplying natural gas to dual-fuel units.

Oilfield operations are conducted in a variety of different locations and involve a number of equipments, depending on the operations at hand. Examples of the various units include fracturing units, cementing units, blending units, material conveying units, trucks, and tractors. In some cases, these units may be powered by natural gas or these units may be dual-fuel vehicles. A dual-fuel vehicle is an alternative fuel vehicle with an internal combustion engine designed to run on more than one type of fuel, for example diesel blended with natural gas.

Conventional natural gas delivery systems involve the use of a central manifold with individual hoses supplying fuel to each individual trailer. These hoses are often run across location and run in the high pressure areas of the operation. This can pose a safety hazard, as the use of these conventional delivery systems may require personnel and equipment to be located in the red zone of the trailers. In addition, conventional natural gas delivery systems often do not have quick disconnects and suffer from the inefficient uses of hoses, increased rig-up times, and increase workload for field hands.

It is desirable to provide a system for supplying fuel from a source to a gas train on a dual-fuel trailer in a safe and efficient manner.

### SUMMARY

The present disclosure relates generally to subterranean drilling and completion operations and, more particularly, the present disclosure relates to a method and apparatus for supplying natural gas to dual-fuel units.

In one embodiment, the present disclosure provides a fuel delivery system comprising: a fuel source; a first trailer comprising a first manifold in fluid communication with a first fuel train; and a second trailer comprising a second manifold in fluid communication with a second fuel train, wherein the first and second manifolds are connected in series to the fuel source.

In another embodiment, the present disclosure provides a method of assembling a fuel delivery system comprising: providing a fuel source; providing at least a first trailer and second trailer, wherein the first and second trailers each comprise a manifold with an inlet, an outlet, and a branch in fluid communication with a fuel train; connecting the fuel source to the inlet of the manifold on the first trailer; and connecting the outlet of the manifold on the first trailer to the inlet of the manifold on the second trailer.

In another embodiment, the present disclosure provides a method of delivering fuel comprising: assembling a fuel delivery system, wherein assembling the fuel delivery system comprises: providing a fuel source; providing at least a first trailer and second trailer, wherein the first and second trailers each comprise a manifold with an inlet, an outlet, and a branch connected to a fuel train; connecting the fuel source to the inlet of the manifold on the first trailer; and connecting the outlet of the manifold on the first trailer to the inlet of the manifold on the second trailer and delivering fuel from the fuel source to the fuel train of the first and second trailers.

The features and advantages of the present invention will be apparent to those skilled in the art from the description of the preferred embodiments which follows when taken in conjunction with the accompanying drawings. While numerous changes may be made by those skilled in the art, such changes are within the spirit of the invention.

### BRIEF DESCRIPTION OF THE DRAWINGS

These drawings illustrate certain aspects of some of the embodiments of the present invention, and should not be used to limit or define the invention.

FIG. 1 illustrates a diagram of a fuel delivery system, incorporating aspects of the present disclosure.

FIG. 2 illustrates a diagram of a fuel delivery system, incorporating aspects of the present disclosure.

While embodiments of this disclosure have been depicted and described and are defined by reference to example embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

The present disclosure relates generally to subterranean drilling and completion operations and, more particularly, the present disclosure relates to a method and apparatus for supplying natural gas to dual-fuel units.

Illustrative embodiments of the present invention are described in detail herein. In the interest of clarity, not all features of an actual implementation may be described in this specification. It will of course be appreciated that in the development of any such actual embodiment, numerous implementation-specific decisions may be made to achieve the specific implementation goals, which may vary from one implementation to another. Moreover, it will be appreciated that such a development effort might be complex and time-consuming, but would nevertheless be a routine undertaking for those of ordinary skill in the art having the benefit of the present disclosure.

To facilitate a better understanding of the present disclosure, the following examples of certain embodiments are given. In no way should the following examples be read to limit, or define, the scope of the disclosure. Embodiments of the present disclosure may be applicable to delivering any type of fuel, including natural gas, to any type of unit.

In one embodiment, the present disclosure is directed to a system for supplying natural gas to a dual-fuel unit. One possible benefit of this system is that it may allow for all manifolds and natural gas hoses to be kept away from the red zone and away from high pressure iron. Another potential advantage of this system is that it is a safe and simple system to rig up, with minimal rig up time and increased safety. Another potential advantage of this system is that it is more cost effective than traditional distribution systems.

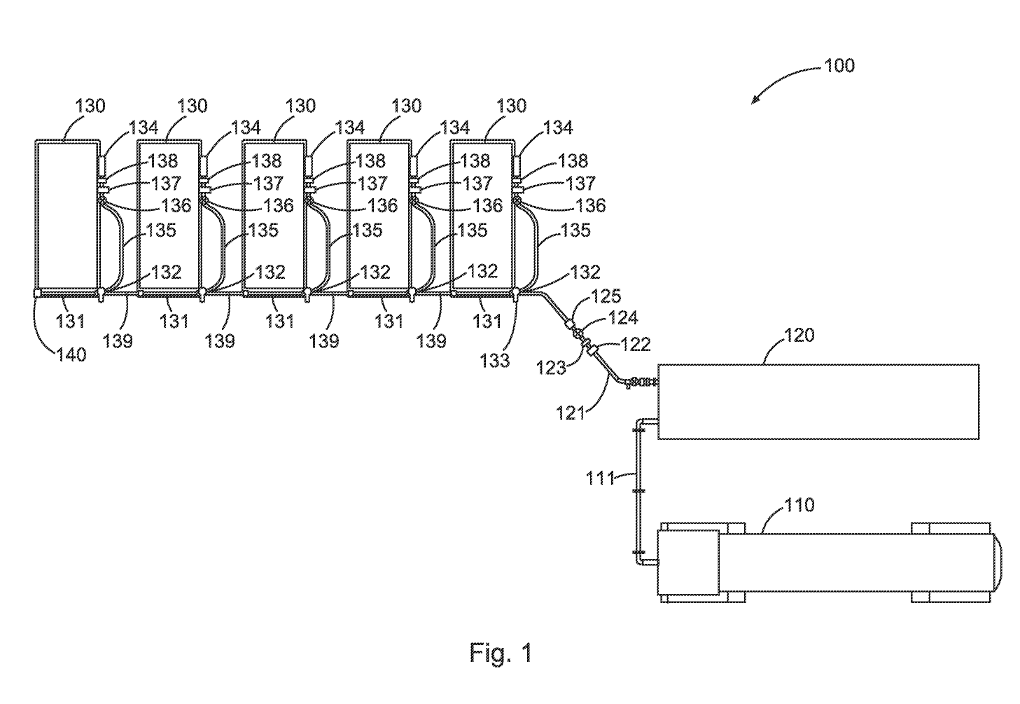

Referring now to FIG. 1, fuel supply system (100) may include one or more of the following: fuel tank (110); vaporizer (120); and trailers (130). Fuel tank (110) may comprise any conventional fuel tank, including but not limited to liquefied natural gas storage, compressed natural gas storage, integrated storage and vaporization units. In certain embodiments, fuel tank (110) may contain up to 20,000 gallon of liquid natural gas or 50 MCF of compressed natural gas. Vaporizer (120) may comprise any conventional vaporizer unit. Examples of conventional vaporizer units include ambient vaporizer units, electric vaporizer units, direct fired vaporizer units, as fired waterbath vaporizer units, and hot water/coolant from engines vaporizer units. Trailers (130) may comprise any conventional trailers that are used in subterranean operations. Examples of trailers include fracturing units, cementing units, blending units, material conveying units, trucks, and tractors.

In certain embodiments, fuel tank (110) may be connected to vaporizer (120) through connection (111). Connection (111) may be a standard piping or tubing known to one of ordinary skill in the art.

In certain embodiments, vaporizer (120) may be connected to a manifold (131) on a first trailer (130) through a connection (121). Connection (121) may be a standard piping, tubing, or hose known to one of ordinary skill in the art. In certain embodiments, connection (121) may include a flow meter (122), a pressure regulator (123), a valve (124) and a nitrogen purge connection (125). In certain embodiments, valve (124) may be a ball valve, a gate valve, or a plug valve. In certain embodiments, connection (121) may be connected to manifold (131) on a first trailer (130) by use of a quick disconnect fitting. In certain embodiments, manifold (131) may comprise flexible hose tubing.

Manifold (131) on first trailer (130) may comprise a branch (132) to which a valve (133) may be connected. In certain embodiments, valve (133) may be a ball valve, a gate valve, or a plug valve. In certain embodiments, valve (133) may be connected to a fuel train (134) of trailer (130) through connection (135). In certain embodiments, connection (135) may comprise flex hose tubing. In certain embodiments, fuel train (134) may comprise a valve (136), a pressure regulator (137), and a methane detector (138). In certain embodiments, fuel train (134) may further comprise an equipment isolation valve, a low gas pressure switch, an automatic safety shutoff valve, a leak check valve, a high pressure gas switch, and a throttle body.

In certain embodiments, manifold (131) may be connected to a manifold (131) on a second trailer (130) through connection (139). In certain embodiments, connection (139) may comprise a quick disconnect fitting. In other embodiments, connection (139) may comprise a jumper hose. In other embodiments, connection (139) may comprise flexible hose tubing. In certain embodiments, the connection (139) may be polyethylene pipe, corrugated stainless steel hose, or any flexible hose rated for natural gas. For example, the connection (139) may be Parker 72-31 Gas Hose. Second trailer (130) and subsequent trailers (130) may share all or some of the features of first trailer (130).

In certain embodiments, as shown in FIG. 1, fuel supply system (100) may comprise 5 trailers (130). However, any number of trailers (130) may be used in this system. FIG. 1 illustrates that the last trailer (130) in this system may include a plug (140) or a valved quick disconnect coupling installed at the end of the last trailer (130) either on manifold (131) or on connection (139) (not illustrated).

When utilizing the system illustrated in FIG. 1, it is possible to supply fuel to any number of trailers in an efficient manner. Once the system is assembled, the valves may be actuated to supply fuel to the trailers. Each valve may be operated independently, allowing an operator to individually select which trailer is to be supplied with fuel. This system utilizes a “daisy chain” design which is different from the spider designs that are used in conventional systems. As illustrated in FIG. 1, each of the trailers may be connected to the fuel source in series rather than in parallel, allowing for an efficient supply process.

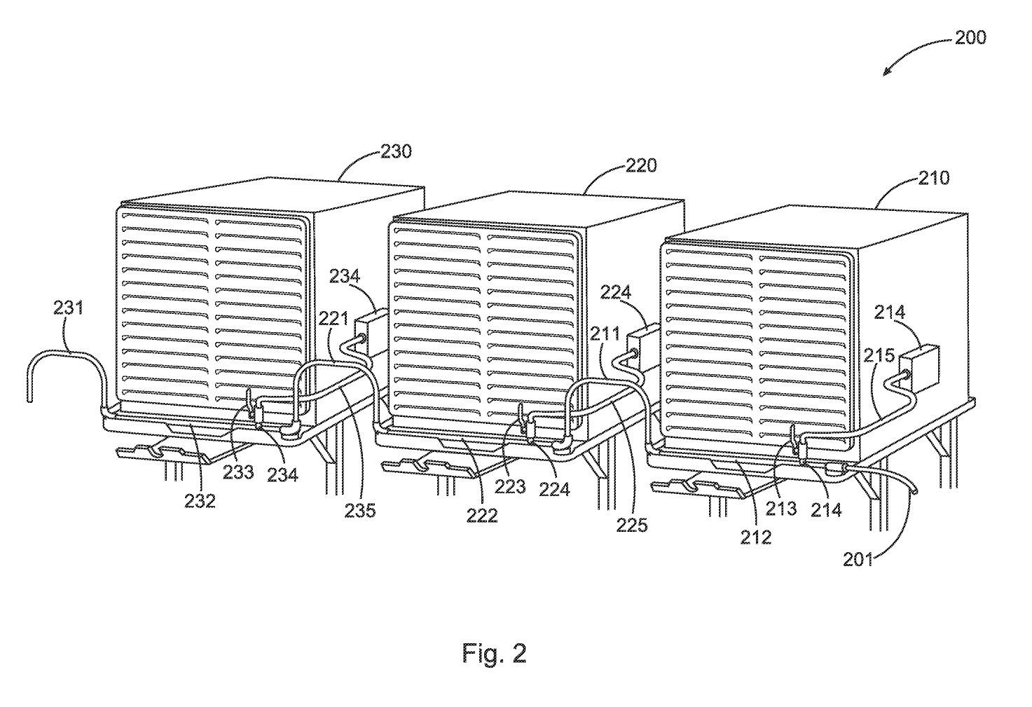

Referring now to FIG. 2, FIG. 2 illustrates a close up view of trailers (210), (220), and (230) in fuel delivery system (200) accordingly to one embodiment of the present disclosure. As can be seen in FIG. 2, connection (201) from a fuel source (not shown) may connect to a manifold (212) of trailer (210). A valve (213) may be connected to a branch (214) in manifold (212). In certain embodiments, valve (213) may be connected to a fuel train (214) by the use of a connection (215). A connection (211) may be used to connect manifold (212) of trailer (210) to manifold (222) of trailer (220). The connection (211) may be flex hose tubing, as described above. Although not illustrated in FIG. 2, the connections between manifolds (222) and (212) may comprise quick disconnect fittings.

In certain embodiments, a valve (223) may be connected to a branch (224) in manifold (222). In certain embodiments, valve (223) may be connected to a fuel train (224) by the use of a connection (225). A connection (221) may be used to connect manifold (222) of trailer (220) to manifold (232) of trailer (230). The connection (221) may be flex hose tubing, as described above. Although not illustrated in FIG. 2, the connections between manifolds (232) and (222) may comprise quick disconnect fittings.

In certain embodiments, a valve (233) may be connected to a branch (234) in manifold (232). In certain embodiments, valve (233) may be connected to a fuel train (234) by the use of a connection (235). A connection (231) may be used to connect manifold (232) of trailer (230) to a manifold of a fourth trailer or alternatively connection (231) may be plugged. The connection (231) may be flex hose tubing, as described above. Although not illustrated in FIG. 2, the connections (231) may comprise a quick disconnect fitting.

In one embodiment, the present disclosure provides a fuel delivery system comprising: a fuel source; a first trailer comprising a first manifold in fluid communication with a first fuel train; and a second trailer comprising a second manifold in fluid communication with a second fuel train, wherein the first and second manifolds are connected in series to the fuel source.

In another embodiment, the present disclosure provides a method of assembling a fuel delivery system comprising: providing a fuel source; providing at least a first trailer and second trailer, wherein the first and second trailers each comprise a manifold with an inlet, an outlet, and a branch in fluid communication with a fuel train; connecting the fuel source to the inlet of the manifold on the first trailer; and connecting the outlet of the manifold on the first trailer to the inlet of the manifold on the second trailer.

In another embodiment, the present disclosure provides a method of delivering fuel comprising: assembling a fuel delivery system, wherein assembling the fuel delivery system comprises: providing a fuel source; providing at least a first trailer and second trailer, wherein the first and second trailers each comprise a manifold with an inlet, an outlet, and a branch connected to a fuel train; connecting the fuel source to the inlet of the manifold on the first trailer; and connecting the outlet of the manifold on the first trailer to the inlet of the manifold on the second trailer and delivering fuel from the fuel source to the fuel train of the first and second trailers.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Also, the terms in the claims have their plain, ordinary meaning unless otherwise explicitly and clearly defined by the patentee. The indefinite articles “a” or “an,” as used in the claims, are defined herein to mean one or more than one of the element that it introduces.

What is claimed is:

1. A fuel delivery system comprising:
a fuel source; a first trailer comprising a first manifold in fluid communication with a first fuel train; and a second trailer comprising a second manifold in fluid communication with a second fuel train, wherein the first and second manifolds are connected in series to the fuel source by a flexible hose.

2. The fuel delivery system of claim 1, wherein the first manifold comprises flexible hose tubing.

3. The fuel delivery system of claim 1, wherein the fuel source comprises a natural gas storage tank.

4. The fuel delivery system of claim 1, wherein the first and second trailers comprise at least one unit selected from the group consisting of: a fracturing unit, a cementing unit, a blending unit, a material conveying units, a truck, and a tractor.

5. The fuel delivery system of claim 1, wherein the fuel source is connected to the first manifold by the use of a quick disconnect fitting.

6. The fuel delivery system of claim 1, wherein the first manifold and the second manifold are connected by the use of a quick disconnect fitting.

7. The fuel delivery system of claim 1, further comprising a third trailer comprising a third manifold in fluid communication with a third fuel train, wherein the third manifold is connected in series to the first and second manifolds and the fuel source.

8. The fuel delivery system of claim 1, wherein the first manifold and the second manifold each comprise a valve.

9. A method of assembling a fuel delivery system comprising:
providing a fuel source;
providing at least a first trailer and second trailer, wherein the first and second trailers each comprise a manifold with an inlet, an outlet, and a branch in fluid communication with a fuel train;
connecting the fuel source to the inlet of the manifold on the first trailer; and
connecting the outlet of the manifold on the first trailer to the inlet of the manifold on the second trailer with a flexible hose.

10. The method of claim 9, wherein the manifold comprises flexible hose tubing.

11. The method of claim 9, wherein the fuel source comprises a natural gas storage tank.

12. The method of claim 9, wherein the first and second trailers comprise at least one unit selected from the group consisting of: a fracturing unit, a cementing unit, a blending unit, a material conveying units, a truck, and a tractor.

13. The method of claim 9, wherein the fuel source is connected to the inlet of the manifold on the first trailer by the use of a quick disconnect fitting.

14. The method of claim 9, wherein the outlet of the manifold on the first trailer is connected to the inlet of the manifold on the second trailer by the use of a quick disconnect fitting.

15. The method of claim 9, further comprising:
providing a third trailer, wherein the third trailer comprises a manifold with an inlet, an outlet, and a branch in fluid communication with a fuel train and
connecting the outlet of the manifold on the second trailer to the inlet of the manifold on the third trailer.

16. A method of delivering fuel comprising:
assembling a fuel delivery system, wherein assembling the fuel delivery system comprises:
providing a fuel source;
providing at least a first trailer and second trailer, wherein the first and second trailers each comprise a manifold with an inlet, an outlet, and a branch connected to a fuel train;
connecting the fuel source to the inlet of the manifold on the first trailer; and
connecting the outlet of the manifold on the first trailer to the inlet of the manifold on the second trailer using a flexible hose; and
delivering fuel from the fuel source to the fuel train of the first and second trailers.

17. The method of claim 16, wherein the fuel source comprises a natural gas storage tank.

18. The method of claim 16, wherein the first and second trailers comprise at least one unit selected from the group consisting of: a fracturing unit, a cementing unit, a blending unit, a material conveying units, a truck, and a tractor.

19. The method of claim 16, wherein the fuel source is connected to the inlet of the manifold on the first trailer by the use of a quick disconnect fitting.

20. The method of claim 16, wherein the outlet of the manifold on the first trailer is connected to the inlet of the manifold on the second trailer by the use of a quick disconnect fitting.
